(19) United States
(12) Patent Application Publication
(10) Pub. No.: US 2005/0271150 A1
(43) Pub. Date: Dec. 8, 2005

(54) Digital modulation system and method

(76) Inventors: Steve Moore, Escondido, CA (US); Douglas Cummings, Carlsbad, CA (US)

Correspondence Address: Peter R Martinez;c/o Pulse-LINK, Inc., 1969 Kellogg Avenue, Carlsbad, CA, 92008, US

(21) Appl. No.: 10/862,480

(22) Filed: Jun. 7, 2004

(51) Int. Cl. H04L 27/00; H04L 7/00

(52) U.S. Cl. 375/259

(57) ABSTRACT

A digital modulation system and method is provided. The present invention employs a communication frame that includes a synchronization section. In addition to providing synchronization function(s), one embodiment of the present invention modulates, or encodes data onto the synchronization section. By using the synchronization section to carry additional data, the amount of data transmitted with each frame is increased. This increases the bandwidth of communication system employing the method of the present invention. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention relates to the field of communications. More particularly the present invention describes a digital modulation system for communication systems.

### BACKGROUND OF THE INVENTION

The Information Age is upon us. Access to vast quantities of information through a variety of different communication systems are changing the way people work, entertain themselves, and communicate with each other.

For example, because of the 1996 Telecommunications Reform Act, traditional cable television program providers have now evolved into full-service providers of advanced video, voice and data services for homes and businesses. A number of competing cable companies now offer cable systems that deliver all of the just-described services via a single broadband network.

These services have increased the need for bandwidth, which is the amount of data transmitted or received per unit time. More bandwidth has become increasingly important, as the size of data transmissions has continually grown. Applications such as in-home movies-on-demand and video teleconferencing demand high data transmission rates. Another example is interactive video in homes and offices.

Other industries are also placing bandwidth demands on Internet service providers, and other data providers. For example, hospitals transmit images of X-rays and CAT scans to remotely located physicians. Such transmissions require significant bandwidth to transmit the large data files in a reasonable amount of time. These large data files, as well as the large data files that provide real-time home video are simply too large to be feasibly transmitted without an increase in system bandwidth. The need for more bandwidth is evidenced by user complaints of slow Internet access and dropped data links that are symptomatic of network overload.

In addition, the wireless device industry has recently seen unprecedented growth. Cellular phones can now transmit images, and providers are scrambling to meet consumer demand for Internet access using their phones. This translates into additional bandwidth demand.

Conventional radio frequency (RF) technology has been the predominant technology for wireless device communication for decades. Conventional RF technology employs continuous carrier sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission (FCC) has allocated cellular phone communications in the 800 to 900 MHz band. Generally, cellular phone operators divide the allocated band into 25 MHz portions, with selected portions transmitting cellular phone signals, and other portions receiving cellular phone signals.

Another type of communication technology is ultra-wideband (UWB). UWB technology employs discrete pulses of electromagnetic energy and is fundamentally different from conventional carrier wave RF technology. UWB generally employs a “carrier free” architecture, which does not necessarily require the use of high frequency carrier generation hardware, carrier modulation hardware, frequency and phase discrimination hardware or other devices employed in conventional frequency domain communication systems.

One feature of UWB is that a UWB signal, or pulse, may occupy a very large amount of RF spectrum, for example, generally in the order of gigahertz of frequency band. Currently, the FCC has allocated the RF spectrum located between 3.1 gigahertz and 10.6 gigahertz for UWB communications. The FCC has also mandated that UWB signals, or pulses must occupy a minimum of 500 megahertz of RF spectrum. One feature of UWB technology is its ability to transmit large amounts of data, thereby providing some of the additional bandwidth demanded by today's consumers and businesses.

Regardless of whether UWB technology or conventional carrier wave technology is employed, a need exists for more bandwidth.

### SUMMARY OF THE INVENTION

The present invention provides a system and method to increase the bandwidth of virtually any type of communication system, regardless of the type of communication media that is employed, or the type of technology used.

The present invention provides a digital modulation, or encoding method that may be applied to virtually any type of communication system and/or device.

One method of the present invention employs a communication frame that includes a synchronization section. In addition to providing synchronization function(s), the present invention also modulates, or encodes data onto the synchronization section. By using the synchronization section to carry additional data, the amount of data transmitted with each frame is increased. This increases the bandwidth of communication system employing the method of the present invention.

The present invention may be employed by communication systems that use conventional carrier waves, or ultra-wideband technology. The present invention may be employed in any type of network, be it wireless, wire, or a mix of wire media and wireless components. That is, a network may use both wire media, such as coaxial cable, and wireless devices, such as satellites, cellular antennas or other types of wireless transceivers.

These and other features and advantages of the present invention will be appreciated from review of the following detailed description of the invention, along with the accompanying figures in which like reference numerals are used to describe the same, similar or corresponding parts in the several views of the drawings.

### BRIEF DESCRIPTION OF THE DRAWING

FIG. 1 is an illustration of different communication methods;

FIG. 2 is an illustration of two ultra-wideband pulses;

FIG. 3 is an illustration of a communication frame structure constructed according to one embodiment of the present invention;

FIG. 4 is an illustration of several communication frames constructed according to FIG. 3; and

FIG. 5 is an illustration of several communication frames constructed according to FIG. 3, with different grouping arrangements according to one embodiment of the present invention.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a system and method for communication, wirelessly or through a wire medium, using either conventional carrier wave technology, or ultra-wideband technology. The present invention provides a digital modulation, or encoding method that may be applied to virtually any type of communication system and/or device.

One method of the present invention comprises modulating, or encoding data onto the synchronization section of a frame. Most communication systems use “frames,” regardless of whether the system uses conventional carrier wave technology or ultra-wideband technology.

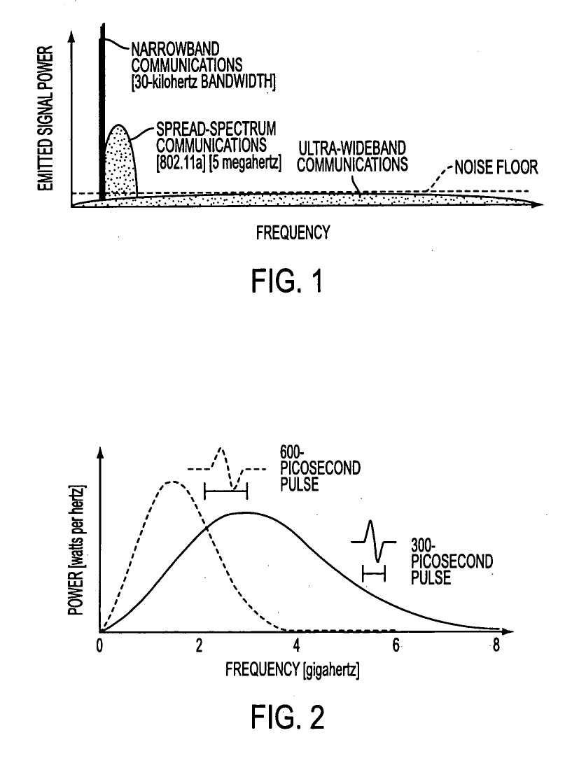

An example of a conventional carrier wave communication technology is illustrated in FIG. 1. IEEE 802.11a is a wireless local area network (LAN) protocol, which transmits a sinusoidal radio frequency signal at a 5 GHz center frequency, with a radio frequency spread of about 5 MHz. As defined herein, a carrier wave is an electromagnetic wave of a specified frequency and amplitude that is emitted by a radio transmitter in order to carry information. The 802.11 protocol is an example of a carrier wave communication technology. The carrier wave comprises a substantially continuous sinusoidal waveform having a specific narrow radio frequency (5 MHz) that has a duration that may range from seconds to minutes. The 802.11 protocol uses “frames” to transmit data.

Ultra-wideband communication technology may also use the methods of the present invention. Ultra-wideband technology is fundamentally different than conventional carrier wave communication technology. Referring to FIGS. 1 and 2, ultra-wideband (UWB) communication employs discrete pulses of electromagnetic energy that are emitted at, for example, nanosecond or picosecond intervals (generally tens of picoseconds to a few nanoseconds in duration). For this reason, ultra-wideband is often called “impulse radio.” That is, the UWB pulses may be transmitted without modulation onto a sine wave, or a sinusoidal carrier, in contrast with conventional carrier wave communication technology. UWB generally requires neither an assigned frequency nor a power amplifier.

FIG. 2 illustrates two UWB pulses, and shows that the shorter the pulse in time, the broader the spread of its frequency spectrum. This is because the frequency spectrum occupied by the UWB pulse is inversely proportional to the time duration of the pulse. A 600-picosecond UWB pulse can have about a 1.8 GHz center frequency, with a frequency spread of approximately 1.6 GHz, and a 300-picosecond UWB pulse can have about a 3 GHz center frequency, with a frequency spread of approximately 3.2 GHz. Thus, UWB pulses generally do not operate within a specific frequency, as shown in FIG. 1. In addition, either of the pulses shown in FIG. 2 may be frequency shifted, for example, by using heterodyning, to occupy essentially the same amount of frequency spectrum, but centered at any desired frequency. Because UWB pulses occupy a large amount of frequency spectrum, UWB communication systems allow communications at very high data rates, such as 100 megabits per second or greater.

Also, because the UWB pulses may occupy a large amount of frequency spectrum, the power sampled in, for example, a one megahertz bandwidth, is very low. For example, UWB pulses of one nano-second duration and one milliwatt average power (0 dBm) spreads the power over the entire one gigahertz frequency band occupied by the pulse. The resulting power density is thus 1 milliwatt divided by the 1,000 MHz pulse bandwidth, or 0.001 milliwatt per megahertz (−30 dBm/MHz).

Generally, in the case of wireless communications, a multiplicity of UWB pulses may be transmitted at relatively low power density (milliwatts per megahertz). However, an alternative UWB communication system may transmit at a higher power density. For example, UWB pulses may be transmitted between +30 dBm to −50 dBm.

UWB pulses, however, transmitted through many wire media will not interfere with wireless radio frequency transmissions. Therefore, the power (sampled at a single frequency) of UWB pulses transmitted though wire media may range from about +30 dBm to about −140 dBm.

Alternate embodiments of UWB may be achieved by mixing baseband pulses (i.e., information-carrying pulses), with a carrier wave that controls a center frequency of a resulting signal. The resulting signal is then transmitted using discrete pulses of electromagnetic energy, as opposed to transmitting a substantially continuous sinusoidal signal.

Several different methods of ultra-wideband (UWB) communications have been proposed. For wireless UWB communications in the United States, all of these methods must meet the constraints recently established by the Federal Communications Commission (FCC) in their Report and Order issued Apr. 22, 2002 (ET Docket 98-153). Currently, the FCC is allowing limited UWB communications, but as UWB systems are deployed, and additional experience with this new technology is gained, the FCC may expand the use of UWB communication technology.

The Institute of Electrical and Electronics Engineers (IEEE) is currently establishing rules and communication standards for a variety of different networks, and other communication environments that may employ ultra-wideband technology. These different communication standards may result in different rules, or physical-layer air interfaces for each standard. For example, IEEE 802.15.3(a) relates to a standard for ultra-wideband Wireless Personal Area Networks (WPANs). Ultra-wideband may also be employed in IEEE 802.15.4 (a standard for sensors and control devices), 802.11n (a standard for Local Area Networks), ground penetrating radar, through-wall imaging, and other networks and environments. Each one of these devices may employ ultra-wideband communication technology, and each device may also have its own communication standard. The methods of the present invention may be employed in any variant of ultra-wideband technology, or in a conventional carrier wave communication system that employs “frames.”

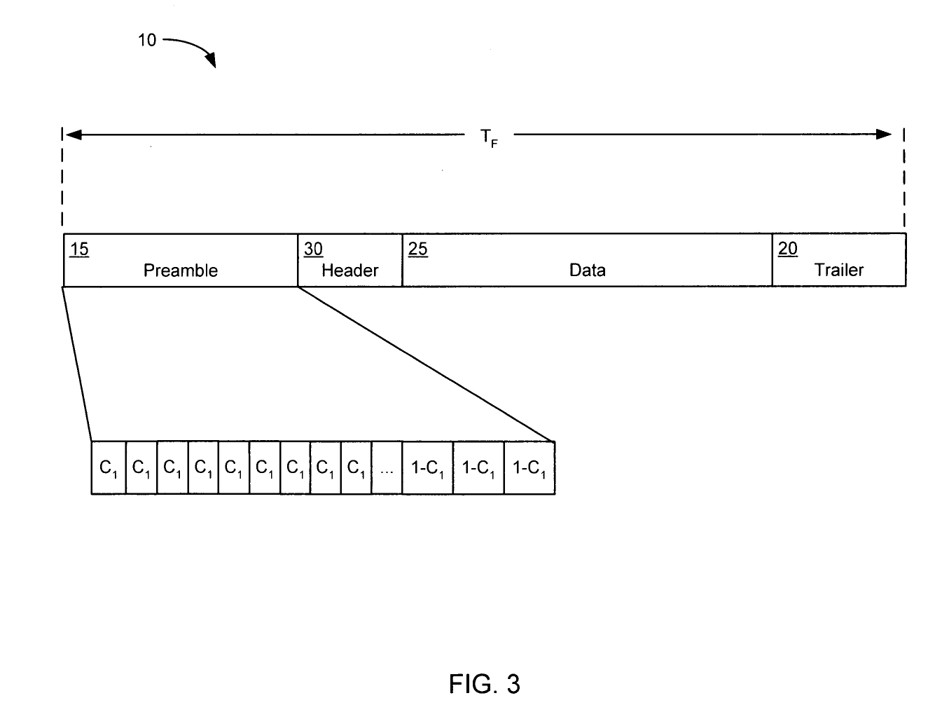

Referring to FIG. 3, a “frame” 10 constructed according to one embodiment of the present invention is illustrated. As mentioned above, one method of the present invention comprises modulating, or encoding data onto the synchronization section of a frame 10. Most communication systems use “frames,” regardless of whether the system uses conventional carrier wave technology or ultra-wideband technology.

A “frame” 10 as defined herein, includes many different constructions and arrangements. Generally, a “frame” 10 is a sequence of bits delimited by, and including, beginning and ending flag sequences. Flag sequences generally comprise a sequence of bits used to mark the beginning and/or end of a frame 10. As shown in FIG. 3, a flag sequence may be in the preamble 15 and/or the trailer 20. A frame 10 may be of different lengths, and contain variable amounts of data.

A frame 10 usually consists of a representation of the original data to be transmitted (generally comprising a specified number of bits, shown as “data” 25 in FIG. 3), together with other bits that may be used for error detection or control. Additional bits may be used for routing (possibly in the form of an address field), synchronization, overhead information not directly associated with the original data, and a frame check sequence (also known as a cyclic redundancy check). The header 30 may include the routing information, such as a source address, a destination address, and other information.

The preamble 15 may include the synchronization section that is used to obtain a fixed relationship among corresponding significant instants of two or more signals. Put differently, the synchronization section is used by a receiver to lock onto an incoming frame so that it may receive the data contained in the frame. Generally, the receiver synchronizes its time base, or reference to the time base of the transmitter.

In conventional communication systems, synchronization (also known as frame synchronization, frame alignment, or framing) generally comprises inserting a non-data bit or bits that are used by the receiver so that it is synchronized with the incoming frame. For example, a “frame synchronization pattern,” generally comprising a recurring pattern of bits, is transmitted that enables the receiver to align its clock, or time reference with the transmitter's time reference (i.e., synchronization). Repetition of the bit pattern helps ensure that the receiver will have an opportunity to “lock” in on the timing of the incoming signal. These bits that comprise the frame synchronization pattern are not data. That is, data 25 (as shown in FIG. 3) as defined herein comprises voice, audio, video, Internet content, or other information of interest. Data in the form of information may provide additional function to a receiving device. The frame synchronization pattern bits are non-data. Conventional communication methods do not use the synchronization section to carry data.

In conventional carrier wave communication systems, the sinusoidal carrier wave itself is used as a synchronization signal. That is, the sinusoidal frequency is used by the receiver's clock for synchronization. By using the carrier wave as the synchronization signal, conventional carrier wave communication systems can quickly and easily achieve synchronization. Then, a pattern of information bits are received and demodulated by the receiver. These bits include frame time, or frame duration, and other information. After the information bits are received, the data is then received and demodulated.

However, ultra-wideband communications generally do not employ a carrier wave. Instead, discrete pulses of electromagnetic energy are transmitted, with pulse durations of nanoseconds or picoseconds. A receiver must synchronize itself by using the received pulses, which is much more difficult than synchronizing to a continuous carrier wave. Therefore, the synchronization section of an ultra-wideband frame contains a significant number of bits to ensure that the receiver has sufficient opportunity to synchronize.

Referring again to FIG. 3, the bits that provide synchronization are located in the code blocks C₁ of the preamble 15, and are generally comprised of representations of groups of ones and zeros (not shown). Preferably these groups of ones and zeros are arranged to form codes, or code sequences, of which many types are known in the art. For example, hierarchal codes, Golay codes, Walsh codes, m-sequence codes and Kasami sequence codes may be used. Each of these codes may contain hundreds, if not thousands, of discrete code sequences. Other codes may also be employed by the present invention. Preferably, codes are selected to provide maximum autocorrelation and minimum cross-correlation. In other words, the codes are selected so that a receiver may easily detect the presence of the code through auto-correlation, and not confuse it with any other code through cross-correlation

As shown in FIG. 3, the codes are repeated in code blocks C₁ so that a receiver has several opportunities to “lock” with a transmitter, or with the frame 10. In a preferred embodiment of the present invention, a number of trailing code blocks 1-C₁ may have the same code in reverse polarity. Reversing the polarity of a code is generally achieved by exchanging each of the binary digits, or bits (1 changes to 0, and 0 changes to 1). In this embodiment, the presence of trailing code blocks 1-C₁ tells the receiver that the ending of the preamble is eminent.

One embodiment of the present invention transmits data based on which code is used in the code blocks C₁. A transmitter modulates, or encodes data to be transmitted by using a look-up table, modulation circuit or encoder to transmit data of interest. When a receiver receives code blocks C₁, it uses them to synchronize with the transmitter or with the frame 10, but it also uses a look-up table, demodulation circuit, decoder or other equivalent device (not shown) to demodulate the bits contained in code block C₁, thereby obtaining data from the code block C₁. Specifically, during demodulation, or decoding, the bits in code block C₁ are exchanged for a new group of bits. The new group of bits may comprise any type of data of interest. Because the bits are the same in each code block C₁, only one code block C₁ is demodulated, or decoded.

Another embodiment uses both the code blocks C₁ and the trailing code blocks 1-C₁ to transmit data. In this embodiment, the look-up table, demodulation circuit, or other equivalent device demodulates the bits contained in one of the code blocks C₁ and in one of the trailing code blocks 1-C₁, thereby obtaining additional data.

It will be appreciated that different bits may be transmitted in each code block C₁, or in trailing code block 1-C₁, however, this makes synchronizing more difficult, as the receiver is no longer receiving the same code repeatedly.

In one embodiment, each code in code block C₁ is comprised of 8 binary digits, or bits. When demodulated, the 8 code bits are converted to 8 other bits. Thus, each frame 10 can transmit an additional 8 bits of data. Alternatively, the 8 code bits may be exchanged for more or less than 8 bits.

In the embodiment that uses both the code blocks C₁ and the trailing code blocks 1-C₁, ten bits of additional data per frame 10 can be transmitted. In this embodiment, an odd number of trailing code blocks 1-C₁ are transmitted. For example, 3, 5, 7 or 9 trailing code blocks 1-C₁ may be transmitted. The four choices (3, 5, 7 or 9) equate to 2 additional bits of data (2²=4). The two bits, combined with the 8 bits obtained from demodulating the code block C₁, results in a total of 10 bits. It will be appreciated that other numbers of trailing code blocks 1-C₁ may be transmitted, such as 2, 4, 6, or 8.

Put differently, if there are 256 (2⁸=256) possible code sequences that may be transmitted in code blocks C₁, and if 4 different numbers of trailing code blocks 1-C₁ can be transmitted, then there are 1024 unique combinations that can represent data (4×256). The amount of data that 1024 unique combinations can represent is 10 bits (2¹⁰=1024). It will be appreciated that the number of unique combinations encompassed by the present invention may be greater than or less than the immediate example. That is, more or less than 10 bits may be represented in each preamble 15.

Generally, the data rate that can be achieved by the methods described above is the number of bits divided by the time period between occurrences of the code. Because the blocks C₁ and 1-C₁ are sent at the beginning of each frame 10, the time period between occurrences is the frame 10 duration T_{F} plus any reserve time period between frames (i.e., guard time). In an environment where guard time is negligible, the number of bits divided by frame duration T_{F} may approximate the data rate.

The lack of a continuous carrier wave forces some ultra-wideband (UWB) communication systems to limit frame duration T_{F} to periods where the clocks in the receivers and transmitters can maintain some coherency. This limitation is in part due to the clock drift between communicating devices. In carrier wave communications the sine wave carrier is present for a predominant amount of time, and this issue generally does not arise.

However, in UWB communications, the actual time spent transmitting frames 10 is relatively short. That is, UWB transmitters have a relatively low duty cycle. This means that, frequently, there is no signal for a receiver to synchronize with. Acquisition and maintenance of synchronization between UWB devices therefore requires substantial effort as compared to conventional carrier wave communications. One result of this difficulty is that UWB communication frames 10 have a relatively short frame duration TF. A UWB device with a 10-microsecond frame duration T_{F} employing the present invention, with the ability to carry 10 bits per preamble 15 could increase its data rate by 1 megabits per second (Mbps).

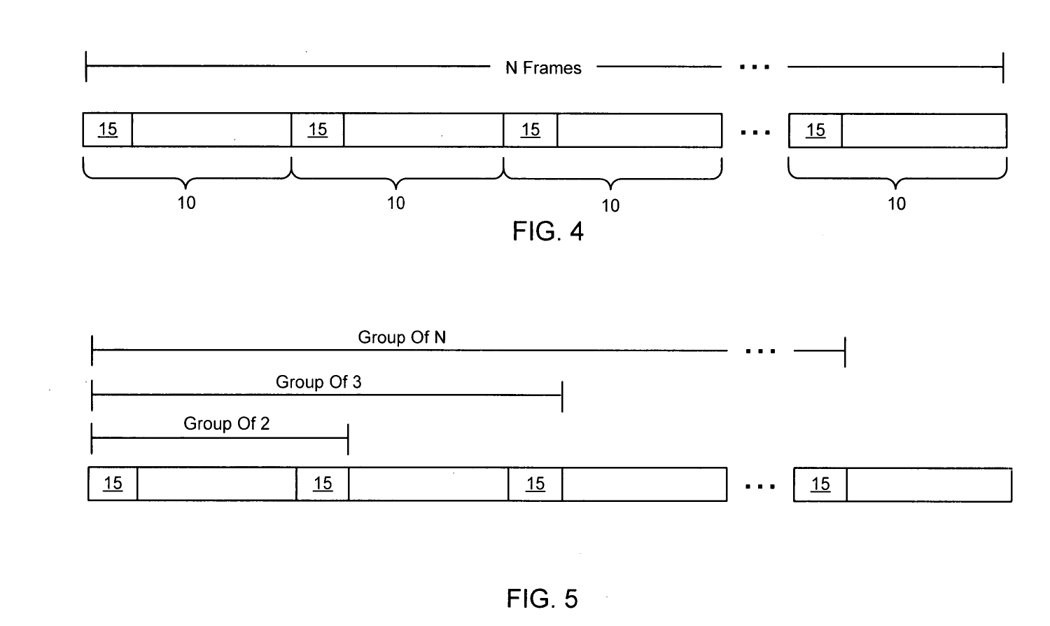

Another embodiment of the present invention is illustrated in FIGS. 4 and 5. In an embodiment described above, the total number of available code sequences times the number of trailing code blocks 1-C₁, referred to hereafter as the number of “states,” is an integer power of 2. For example, in the case where there are 256 (2⁸=256) possible code sequences that may be transmitted, and if 4 different numbers of trailing code blocks 1-C₁ can be transmitted, then there are 1024 unique combinations. In this case, 1024=2¹⁰. This allows each preamble 15 to transmit 10 bits, in addition to its synchronization code.

In the case where the total number of code sequences times the number of trailing code blocks 1-C₁ is not an integer power of 2, conventional modulation techniques usually truncate the available states to the highest power of 2. For example, 11 states are truncated to 8 (2³=8), and 23 states are truncated to 16 (2⁴=16).

Referring to FIGS. 4 and 5, in another embodiment of the present invention, preambles 15 are grouped across frames 10. By grouping the states, the total number of states may be increased. For example, usually 3 states are truncated to 2, and only one bit can be represented (2¹=2). However, in a case where 3 states occur in each preamble 15, two preambles 15 may be grouped, resulting in 3²=9 possible numbers of states. That is, 3^{N} is the number of possible states, where N is the number of grouped preambles 15. In the example where N=2, resulting in 9 possible states, 9 is truncated to 8, and three bits can now be transmitted with each preamble 15 (2³=8). In this example, this method increases the data rate by 50%. As shown in FIG. 5, the numbers of preambles 15 may be sampled in any number of groups, such as Group of 2, Group of 3 or Group of N, where N is may be up to thousands of preambles 15.

The methods described above can provide additional payload, or bandwidth in a communication system. This additional capacity can be used to transmit more data 25, or it may be used to provide other functionalities to a communication system. For example, the additional payload may be used as a separate communication channel, or logical channel, between communication devices, since it is independent of the data 25 section of the frame 10.

As discussed above, currently, there are several different ultra-wideband (UWB) communication systems under consideration. One UWB communication method may transmit UWB pulses that occupy 500 MHz bands within the 7.5 GHz FCC allocation (from 3.1 GHz to 10.6 GHz). In one embodiment of this communication method, UWB pulses have about a 2-nanosecond duration, which corresponds to about a 500 MHz bandwidth. The center frequency of the UWB pulses can be varied to place them wherever desired within the 7.5 GHz allocation. In another embodiment of this communication method, an Inverse Fast Fourier Transform (IFFT) is performed on parallel data to produce 122 carriers, each approximately 4.125 MHz wide. In this embodiment, also known as Orthogonal Frequency Division Multiplexing (OFDM), the resultant UWB pulse, or signal is approximately 506 MHz wide, and has a 242 nanosecond duration. It meets the FCC rules for UWB communications because it is an aggregation of many relatively narrow band carriers rather than because of the duration of each pulse.

Another UWB communication system being evaluated by the IEEE standards committees comprises transmitting discrete UWB pulses that occupy greater than 500 MHz of frequency spectrum. For example, in one embodiment of this communication method, UWB pulse durations may vary from 2 nanoseconds, which occupies about 500 MHz, to about 133 picoseconds, which occupies about 7.5 GHz of bandwidth. That is, a single UWB pulse may occupy substantially all of the entire allocation for communications (from 3.1 GHz to 10.6 GHz).

Yet another UWB communication system being evaluated by the IEEE standards committees comprises transmitting a sequence of pulses that may be approximately 0.7 nanoseconds or less in duration, and at a chipping rate of approximately 1.4 giga pulses per second. The pulses are modulated using a Direct-Sequence modulation technique, and is called DS-UWB. Operation in two bands is contemplated, with one band is centered near 4 GHz with a 1.4 GHz wide signal, while the second band is centered near 8 GHz, with a 2.8 GHz wide UWB signal. Operation may occur at either or both of the UWB bands. Data rates between about 28 Megabits/second to as much as 1,320 Megabits/second are contemplated.

Thus, described above are three different systems, or methods of ultra-wideband (UWB) communication. Each method may also include a common signaling mode, or protocol, that will allow devices employing different UWB communication methods to communicate with each other. The additional bandwidth provided by the present invention may be used to provide communication between these different UWB communication systems.

Alternatively, the additional bandwidth provided by the present invention may be used for channelization. A particular code may be assigned to a particular device or group of devices. Devices not within that group, or devices using another code will be unable to “lock” to the frame 10 since their correlation will be minimal. Without the appropriate code for the group, a device would not be able to detect, receive, and demodulate the data 25 from the frame 10. In this manner, devices in one network may communicate with each other in the presence of devices from another network, without the information being received by the non-network device.

There are many uses for the additional bandwidth provided by the present invention, such as: a beacon timing channel; a beacon ranging channel; a low-bandwidth communications link for low-bandwidth devices; a power conservation function for mobile devices, or other devices with limited power reserve; a dynamic node-to-node power transmit/receive power control function; a network status/health/control status provider; an over-the-air reprogramming link; an over-the-air rekeying link; a “shut-down” function; and a method for routing updates in a mesh network. Each of these functions will be described below:

Beacon Timing Channel: By functioning as a communication channel that all wireless systems are capable of using, the present invention could provide for time precision across wireless networks by functioning as a wireless beacon. In a preferred embodiment, different PHYs would be able to access a common beacon. For example, a Bluetooth-enabled device, and a 802.11-enabled device would access a common beacon channel. This aspect of the present invention would enable the sharing of time information across wireless networks. By sharing time estimations between wireless devices, it becomes possible to generate highly precise time estimates across the network. Higher time accuracy across the network has the potential to provide for increased capacity, especially in Time Division Multiple Access (TDMA) networks by allowing higher time precision TDMA protocols to be utilized.

Beacon Ranging Channel: The present invention may also enable a communication device to function as a wireless positioning beacon. By allowing a communication device to function as a beacon node, positioning applications would become more easily implemented. A second device may engage in a two-way ranging process. Two-way ranging enables very accurate ranging, and may provide an indoor E-911 position capability.

The present invention may also provide a low-bandwidth communications link for low-bandwidth devices. Low bandwidth messaging saves bandwidth for users that need additional bandwidth. For example, a low bandwidth security sensor need not utilize a high-bandwidth communications link to report its status information, thereby saving that high-bandwidth capacity for other applications.

The present invention may also provide a power conservation function for mobile devices, or other devices with a limited power reserve. By providing a low-bandwidth communications channel, the present invention enables power conservation in mobile or power-limited devices. For example, devices requiring a low-bandwidth channel would not need to monitor a high-bandwidth channel to acquire or pass low-bandwidth information. In this fashion, a power-limited device is able to improve its power conservation, thereby ensuring longer operation.

The present invention may provide dynamic node-to-node power transmit/receive power control. That is, the present invention may allow wireless links to dynamically control the power transmitted by each end of the link (i.e., each communicating device) to ensure only the minimum transmit power is used to maintain the link. This would be advantageous in applications such as mesh networking to ensure that the local RF environment was kept at the minimum level needed to maintain all the links. Additionally, this functionality of transmit power control allows a wireless device to take advantage of changing regulatory transmit power limits.

The present invention may provide network status/health/control information. Network status, health and control information could be provided over the low-bandwidth, out-of-band channel. For example, updates on node availability in a wireless mesh network could utilize a low-bandwidth, out-of-band channel instead of occupying a high-bandwidth channel.

The present invention may provide an over-the-air reprogramming link. The present invention may pass new communications algorithms, or other programming information to a device to enable new functionality. For example, a device employing a software definable radio (SDR) may receive a program that allows the device to transmit a new waveform. By providing real-time reprogramming, the device's transmission characteristics or capability may be altered, as needed. As regulations change with respect to software definable radios and other cognitive radios, the present invention may be used to update software and firmware to conform to the new regulations. This over-the-air reprogramming function will allow devices to comply with a changing regulatory environment, thereby reducing the cost of redesign and replacement of wireless devices to designers, manufacturers, and consumers alike.

The present invention may provide an over-the-air rekeying function. The present invention may provide an encryption key distribution function for secure networks, thereby enabling over-the-air rekeying of encryption devices. This function may provide security in a communications network.

The present invention may also provide a “shut down” function. Wireless devices may not be accepted in all locations for reasons that vary from security concerns to social reasons. For example, wireless devices are not yet approved for use on airplanes for safety of flight reasons; they are not approved in hospitals for safety of life reasons; and they are typically not desired in movie theaters for social reasons. The present invention may provide a turn-off function to allow businesses, and others to shut down devices when necessary.

The present invention may be used in a mesh network for routing updates. One problem in mobile mesh networks is the updating of routing information to nodes that are already saturated with traffic. By providing a separate, out-of-band signaling channel, the present invention could provide updated routing information to saturated nodes, thereby permitting them to off-load traffic to different nodes. Additionally, traffic bandwidth would not be used to carry common routing information, which would be sent out-of-band, instead of occupying a data, or bit-providing channel.

In addition to providing the above functions, the present invention may also be used to transmit interference conditions at a receiver to other devices. The present may provide a communication channel that could be used by transceivers to communicate information on the local interference conditions. This would allow transceivers to dynamically adjust transmit power based upon the target receiver, thereby ensuring the local interference does not jam, or otherwise degrade the transmission. Additionally, the transmit power may be adjusted in light of the interference to avoid exceeding an emission level.

The present invention may be employed in any type of communication system, or network, be it wireless, wire, or a mix of wire media and wireless components. That is, a network may use both wire media, such as coaxial cable, and wireless devices, such as satellites, or cellular antennas. As defined herein, a network is a group of points or nodes connected by communication paths. The communication paths may use wires or they may be wireless. A network as defined herein can interconnect with other networks and contain sub-networks. A network as defined herein can be characterized in terms of a spatial distance, for example, such as a local area network (LAN), a personal area network (PAN), a metropolitan area network (MAN), a wide area network (WAN), and a wireless personal area network (WPAN), among others. A network as defined herein can also be characterized by the type of data transmission technology used by the network, such as, for example, a Transmission Control Protocol/Internet Protocol (TCP/IP) network, a Systems Network Architecture network, among others. A network as defined herein can also be characterized by whether it carries voice, data, or both kinds of signals. A network as defined herein may also be characterized by users of the network, such as, for example, users of a public switched telephone network (PSTN) or other type of public network, and private networks (such as within a single room or home), among others. A network as defined herein can also be characterized by the usual nature of its connections, for example, a dial-up network, a switched network, a dedicated network, and a non-switched network, among others. A network as defined herein can also be characterized by the types of physical links that it employs, for example, optical fiber, coaxial cable, a mix of both, unshielded twisted pair, and shielded twisted pair, among others.

Thus, it is seen a digital modulation communication system is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

1. A modulation method, the method comprising the steps of:
generating a communication frame, the frame including a synchronization section; and
encoding data onto the synchronization section.

2. The modulation method of claim 1, wherein the step of encoding data is performed before the step of generating the communication frame.

3. The modulation method of claim 1, further comprising the steps of:
transmitting the communication frame;
receiving the communication frame; and
decoding the data from the synchronization section.

4. The modulation method of claim 1, wherein the synchronization section is located in a preamble section of the communication frame.

5. The modulation method of claim 1, wherein the communication frame further comprises a data section and a trailer section.

6. The modulation method of claim 1, wherein the synchronization section comprises a first orthogonal code and a second orthogonal code, with the second orthogonal code comprising a reverse polarity of the first orthogonal code.

7. The modulation method of claim 1, wherein the communication frame is transmitted using a plurality of discrete electromagnetic pulses, with each pulse having a duration that ranges between about 10 picoseconds to about 1 millisecond.

8. The modulation method of claim 1, wherein the communication frame is transmitted using a plurality of ultra-wideband pulses.

9. The modulation method of claim 1, wherein the communication frame is transmitted using a sinusoidal carrier wave.

10. The modulation method of claim 1, wherein the communication frame is transmitted wirelessly or through a wire medium.

11. A communication method, the method comprising the steps of:
generating at least two communication frames, with each frame including a preamble section containing at least one individual binary code;
encoding data to the individual binary codes;
transmitting the communication frames;
receiving the communication frames;
grouping the individual binary codes; and
obtaining data from the grouped binary codes.

12. The communication method of claim 11, wherein the step of encoding data to the individual binary codes comprises assigning a set of bits to the individual binary codes of the preamble sections.

13. The communication method of claim 11, wherein the step of obtaining data from the grouped binary codes comprises demodulating a set of bit values represented by the grouped binary codes.

14. The communication method of claim 11, wherein each preamble section comprises a first orthogonal code and a second orthogonal code, with the second orthogonal code comprising a reverse polarity of the first orthogonal code.

15. The communication method of claim 11, wherein each of the communication frames is transmitted using a plurality of ultra-wideband pulses.

16. The communication method of claim 11, wherein each of the communication frames is transmitted using a sinusoidal carrier wave.

17. The communication method of claim 11, wherein each of the communication frames is transmitted wirelessly or through a wire medium.

18. A modulation method, the method comprising the steps of:
means for generating a communication frame, the frame including a synchronization section; and
means for encoding data onto the synchronization section.

19. The modulation method of claim 18, wherein the communication frame is transmitted using a plurality of ultra-wideband pulses.

20. The modulation method of claim 18, wherein the communication frame is transmitted using a sinusoidal carrier wave.
